(19) United States
(12) Patent Application Publication
(10) Pub. No.: US 2009/0206061 A1
(43) Pub. Date: Aug. 20, 2009

(54) Method of controlling the fusing and fusing apparatus

(75) Inventors: Tadashi Kawagoe, Obu-city (JP); Kazuyoshi Suzuki, Chita-gun (JP); Hajime Fushimoto, Chiryu-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/290,212

(22) Filed: Oct. 28, 2008

(30) Foreign Application Priority Data
Feb. 14, 2008 (JP) 2008-033342

(51) Int. Cl. B23K 11/24

(52) U.S. Cl. 219/110

(57) ABSTRACT

A method of controlling fusing by executing a process of peeling a coating by correspondingly controlling the electric current flowing into a coated electric wire 3 through a bent terminal 2 while monitoring the surface temperature of the bent terminal 2 at the time of welding a work W that has the coated electric wire 3 held by the bent terminal 2 by flowing the electric current into the coated electric wire 3 through the bent terminal 2; and a process of thermal caulking by correspondingly controlling the electric current flowing into the coated electric wire 3 through the bent terminal 2 while monitoring the quantity of heat generated in the work W.

### BACKGROUND OF THE INVENTION

1. Technical Field of the Invention

This invention relates to a method of controlling and fusing apparatus, in conducting the fusing to weld placing a coated electric wire between a bent terminal, makes it possible to stably weld without the need of electroplating the terminal.

2. Description of the Related Art

Fusing is known as a solid-phase junction for joining solid materials together. Fusing refers to thermal caulking in which an electric current is flown between a press-contacted coated conductor and a terminal to generate heat resistance to remove the coating, and thereafter, the exposed conductor is press-contacted and joined to the terminal in a state of being heated by flowing the electric current. Fusing is an intermetallic junction method that is adapted to a case where the insulation coating is a heat-resistant coating having a carbonizing temperature of, for example, 370° C. in which soldering cannot be effected.

Japanese Unexamined Patent Publication JP-A-2001-138064 discloses a method of controlling the quality of resistance welding, a method of resistance welding and an apparatus for resistance welding, i.e., voltage across a pair of electrodes is measured, the quantity of heat generated by a core wire to be welded is calculated based on the voltage, and the quality of welding the electric wire in which the core wires are welded together is decided based on the quantity of heat that is generated.

JP-A-2007-166871, on the other hand, discloses a method of removing the coating from the coated electric wire and a method of treating the ends of the coated electric wire, i.e., JP-A-2007-166871 refers to removing the coating material in an intermediate portion of the electric wire, and removing the coating material from the core wire by controlling an annular slit-forming device and a straight slit-forming device at their respective timings.

Further, JP-A-2005-125350 discloses that temperature is detected at a terminal-coupling portion and the welding current is controlled in order to prevent cracks at the bent terminal.

To maintain fusing stability, it is a general practice to electroplate the terminal causing, an increase in the number of steps of electroplating and inevitably pushing up the cost of producing products.

However, if the fusing is conducted by a current method without effecting the electroplating, the junction strength disperses, unacceptable products increases, and the yield decreases.

Therefore, the present applicant has classified the process of fusing into a process for peeling the coating and a process for thermal caulking, has correspondingly controlled the respective processes, and has come to achieve the fusing which features stable junction strength.

In other words, in the process for peeling the coating, attention is placed on the insulating material used for the coated electric wire which is carbonized at about 300 to about 400° C., and sublimates and fumes upon being heated, and therefore the coating is removed.

In the thermal caulking process, on the other hand, attention is placed on stable junction strength which can be obtained if the quantity of heat imparted to the work is optimized.

It was discovered that upon controlling the above two processes in optimum manners, even if the terminal that has not been electroplated is fused, reduction in costs becomes possible with the stabilization of the junction strength.

### SUMMARY OF THE INVENTION

The present invention was proposed from the above point of view and has an object of providing a method of controlling the fusing by classifying the process of fusing into a process of peeling the coating and a process of thermal caulking, executing the corresponding controls for the divided processes to realize the fusing featuring a stable junction strength and also making it possible to decrease the cost of producing the products, and a fusing apparatus.

In order to solve the above problem according to a first aspect of the present invention, there is provided a method of controlling the fusing by executing:

a process of peeling the coating by correspondingly controlling the electric current flowing into a coated electric wire (3) through a bent terminal (2) while monitoring the surface temperature of the bent terminal (2) at the time of welding a work (W) that has the coated electric wire (3) held by the bent terminal (2) by flowing the electric current into the coated electric wire (3) through the bent terminal (2); and

a process of thermal caulking by correspondingly controlling the electric current flowing into the coated electric wire (3) through the bent terminal (2) while monitoring the quantity of heat generated in the work (W).

By controlling the above two processes in optimum manners, it is possible to obtain stable junction strength while suppressing the cost of production even when the fusing is conducted by using the terminal (2) that has not been electroplated.

According to a second aspect of the invention, the process of peeling the coating correspondingly controls the electric current flowing into the coated electric wire (3) through the bent terminal (2) while monitoring the surface temperature of the bent terminal (2), detecting the timing at which the temperature rises again after having dropped once, and so regarding that the coating of the coated electric wire (3) has sublimated and peeled.

This makes it possible to execute the process of peeling the coating while maintaining high precision.

According to a third aspect of the invention, the process of thermal caulking measures the quantity of heat generated in the work (W) to find the quantity of heat that is imparted, and interrupts the flow of current when the quantity of heat has reached a preset quantity of heat.

This makes it possible to execute the process of thermal caulking while maintaining high precision and conduct the fusing without waste.

According to a fourth aspect of the invention, further, there is provided a fusing apparatus for conducting the fusing to weld a coated electric wire (3) in a manner of being held in a bent terminal (2), comprising:

a pair of electrodes (4) for holding a work (W) having the coated electric wire (3) held in the bent terminal (2);

a welding power source (5) for flowing an electric current to the electrodes (4);

a temperature-measuring device (6) for detecting the surface temperature of the bent terminal (2);

a current sensor (7) for detecting the electric current flowing into the electrodes (4);

a process of peeling the coating which monitors the surface temperature of the bent terminal (2) using the temperature-measuring device (6), detects the timing at which the temperature rises again after having dropped once, outputs a control signal to a welding power source (5), and correspondingly controls the electric current flowing into the coated electric wire (3) through the bent terminal (2), and a control unit (8) which integrates the surface temperatures of the bent terminal (2) to find a quantity of heat that is imparted, and outputs a control signal for interrupting the flow of electric current at a moment when the quantity of heat has reached a preset quantity of heat.

A control signal is output to the welding power source (5) based on the temperature of the bent terminal (2) detected by the temperature-measuring device (6) and on the current detected by the current sensor (7). Therefore, the junction strength is stabilized even when the terminal that has not been electroplated is fused, and the cost of producing the products can be suppressed.

The reference numerals in parentheses representing the above means also apply to concrete means appearing in the embodiments described later.

The present invention may be more fully understood from the description of preferred embodiments of the invention, as set forth below, together with the accompanying drawings.

### BRIEF DESCRIPTION OF THE DRAWINGS

In the drawings:

FIG. 1 is a view schematically illustrating the constitution of a fusing apparatus for conducting the fusing according to the present invention;

FIG. 2 is a view schematically illustrating a step of fusing where a coated electric wire is pressed being held by a terminal;

FIG. 3 is a view schematically illustrating the step of fusing where an electric current starts flowing with the coated electric wire being pressed while being held by the terminal;

FIG. 4 is a view schematically illustrating the step of fusing where the coating is being peeled off due to the heat generated in the terminal by the flow of electric current;

FIG. 5 is a view schematically illustrating the step of fusing where the terminal and the electric wire are in direct contact after the coating is peeled off, and the electric current is flowing into the terminal as well as into the electric wire;

FIG. 6 is a view schematically illustrating the step of fusing of when the welding is completed;

FIG. 7 is a flowchart illustrating a method of controlling the fusing according to the invention;

FIG. 8 is a graph comparing dispersion in the measured thickness of the works attained by the method of controlling the fusing of the invention and by the fusing of a prior art;

FIG. 9 is a graph comparing dispersion in the welded strength attained by the method of controlling the fusing of the invention and by the fusing of the prior art; and

FIG. 10 is a graph comparing variation in the thickness of the works of when the electric current is varied by the method of controlling the fusing of the invention and by the fusing of the prior art.

### DESCRIPTION OF THE PREFERRED EMBODIMENTS

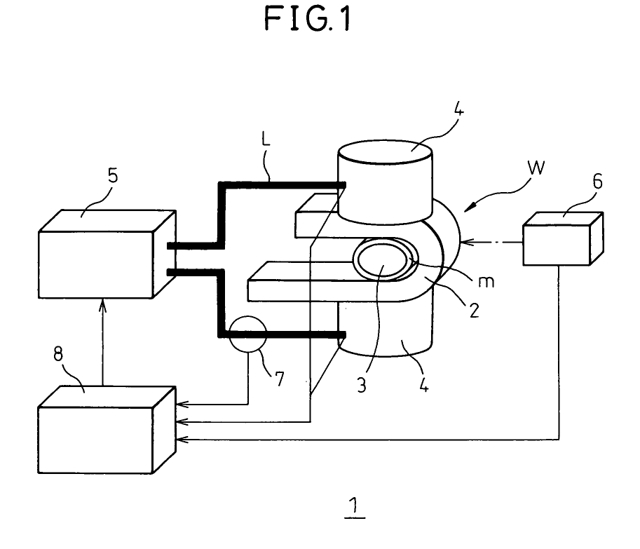

FIG. 1 illustrates a fusing apparatus 1.

The fusing apparatus 1 conducts the fusing to weld a work W which has a coated electric wire 3 held by a bent terminal 2.

Namely, the fusing apparatus 1 has a pair of electrodes 4 for holding the work W that has the coated electric wire 3 held by the bent terminal 2, and flows an electric current under a pressed condition by being pressed by a predetermined pressing means.

Further, the fusing apparatus 1 includes a welding power source 5 for flowing an electric current to the electrodes 4 through conductors L for flowing electric current, a temperature-measuring device 6 for detecting the temperature of the bent terminal 2, and a current sensor 7 provided on the conductor L for flowing electric current and for detecting the electric current flowing into the electrodes 4.

The fusing apparatus 1, further, includes a control unit 8 which outputs a current instruction and any other control instructions to the welding power source 5 based on the electric current flowing into the pair of electrodes 4, the temperature of the bent terminal 2 detected by the temperature-measuring device 6 and the electric current detected by the current sensor 7.

The bent terminal 2 is an electrically conducting thin metal (Cu, etc.) plate and is holding the coated electric wire 3 therein being pressed by suitable pressing means (not shown) via the pair of electrodes 4. The electrodes are made of, for example, tungsten or the like in a cylindrical shape and receive a welding current from the welding power source 5 that will be described later through the conductors L for flowing electric current.

The coated electric wire 3 has a known heat resistant insulation coating m formed on the surface thereof.

The welding power source 5 may be, for example, of the AC type or the inverter type of which the output waveform can be controlled. For example, upon receipt of a current instruction and any other control instructions from the control unit 8 that will be described later, the welding power source 5 controls the current-flowing time and the output waveform to produce a desired welding current, i.e., continuously controls the electric current without rest time to continuously elevate the temperature at the welding portion featuring high heat efficiency.

The temperature-measuring device 6 may be, for example, an infrared-ray temperature sensor of the non-contact type and is so disposed as to detect the temperature at the bent position of the bent terminal 2 holding the coated electric wire 3 therein. The temperature-measuring device 6 outputs a voltage signal corresponding to the detected temperature to the control unit 8 that will be described later.

The current sensor 7 may be a clamp type AC current sensor (current transformer). Or, a Hall current sensor utilizing a Hall element may be used. The current sensor 7 outputs, to the control unit 8, a voltage signal corresponding to a welding current fed to the electrodes 4.

The control unit 8 has a known hardware constitution (I/O interface, CPU, memory, etc.), receives detection signals from the temperature-measuring device 6 and the current sensor 7, processes the signals and predetermined data, executes the arithmetic operation and decision based on preset programs, and transmits a corresponding current instruction and any other control instructions to the welding power source 5.

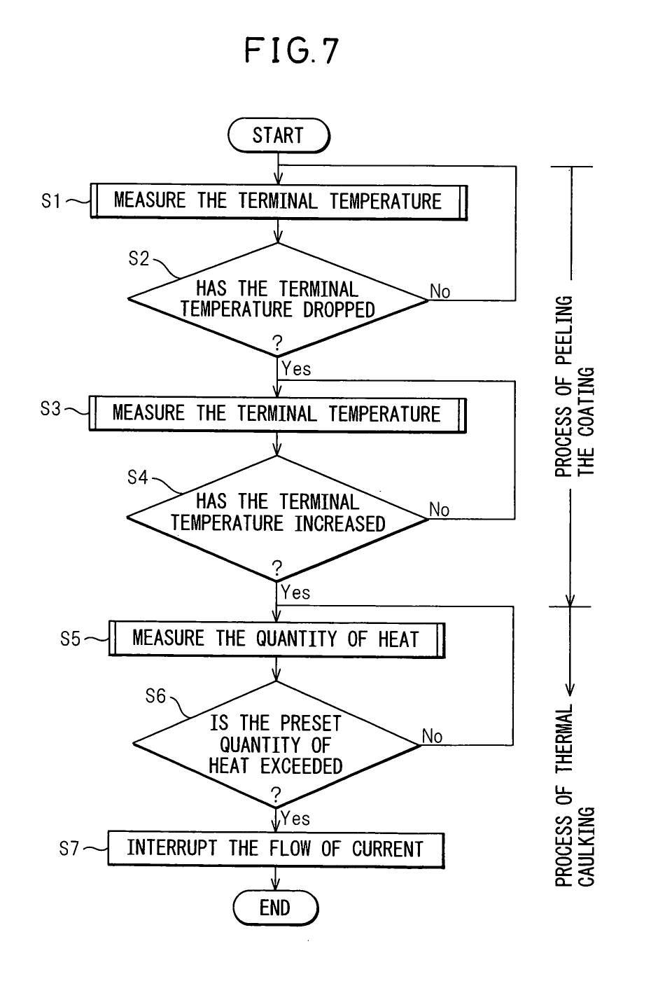

A procedure of fusing by the above fusing apparatus 1 will now be described with reference to a flowchart shown in FIG. 7.

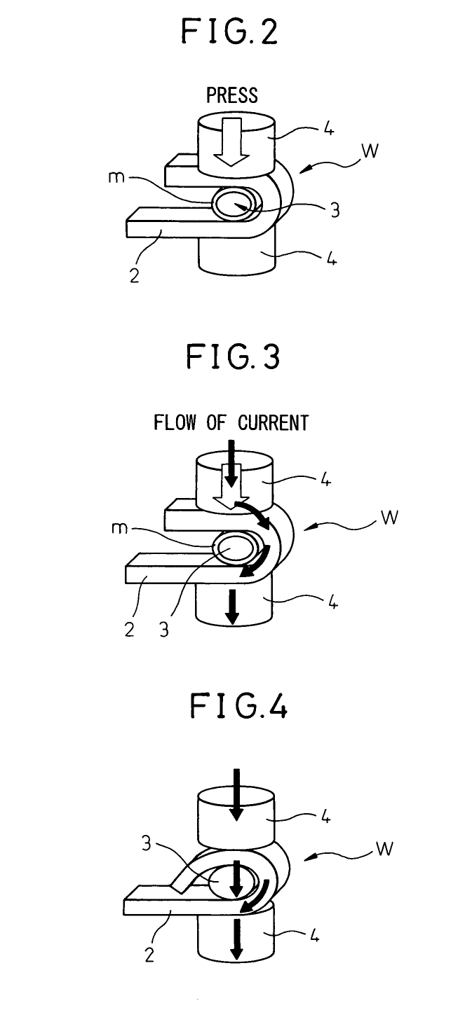

First, the coated electric wire 3 to be fused is held by the bent terminal 2 at the bent position thereof, held between the pair of electrodes 4, and is pressed by predetermined pressing means via the electrodes 4 (see FIG. 2).

The fusing apparatus 1 is driven to flow an electric current from the welding power source 5 to the pair of electrodes 4 through the conductors L for flowing electric current (see FIG. 3).

The electric current, first, flows through the terminal 2. Therefore, the ends of the two electrodes 4 and the terminal 2 generate heat, and the coated electric wire 3, too, generates heat being held by the terminal 2.

As the coated electric wire 3 generates heat, the coating m covering the surface softens and is peeled being pushed out of the terminal 2. Therefore, contact surfaces of the terminal 2 and of the coated electric wire 3 come into direct contact with each other and become electrically conducting (see FIG. 4).

The above process proceeds as the process of peeling the coating according to a program that has been set (see FIG. 7), i.e., the temperature-measuring device 6 in the fusing apparatus 1 is monitoring the temperature on the surface of the bent terminal 2 (FIG. 1, step 1). If a drop in the temperature is detected by the temperature-measuring device 6 (step S2), it can be so considered that the coating m covering the surface is softened and is peeled being pushed out of the terminal 2 as described above. In other words, when the coating m is going to be peeled off, heat is absorbed by the coating m and, therefore, the temperature once drops. The temperature drops not only when the heat is absorbed by the coating m but also when the current density decreases due to the electrically conducting state established between the terminal 2 and the coated electric wire 3.

Moreover, as the temperature-measuring device 6 monitors the temperature on the surface of the bent terminal 2 (step S3) and detects a rise in the temperature on the surface (step 4), it is so regarded that the coating m of the coated electric wire 3 has sublimated and is peeled off. Therefore, the process of peeling the coating is changed over to the process of thermal caulking according to a program that has been set. The control unit 8 correspondingly controls the electric current flowing into the coated electric wire 3 through the bent terminal 2.

In this case, the electrically conducting state is established between the terminal 2 and the coated electric wire 3, and an allowable current increases. Therefore, the control unit 8 sends a control instruction to the welding power source 5 in order to increase the amount of electric current.

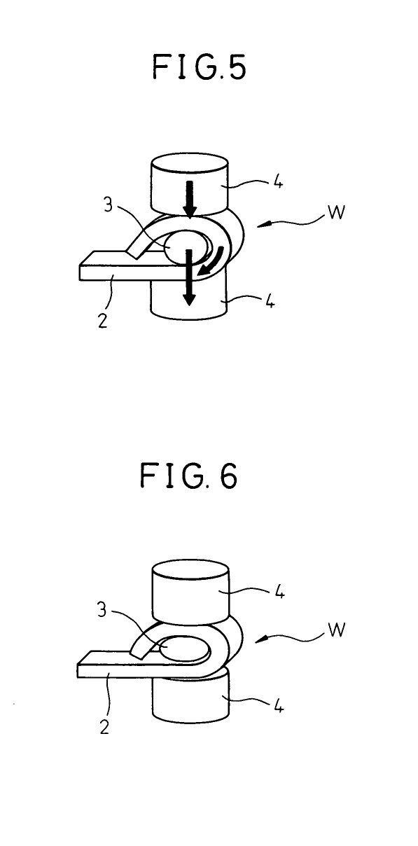

Thus, the welding of the terminal 2 with the coated electric wire 3 proceeds, which is the process of thermal caulking (see FIG. 5).

The control unit 8 executes the measurement of heat quantity (step S5). The quantity of heat can be found by measuring, for example, the electric current and the voltage across the electrodes, i.e., the data related to the quantity of heat are picked up from the electric current flowing into the electrodes 4 detected by the current sensor 7 and from the voltage across the pair of electrodes 4, e.g., from the data table stored in a memory, or a predetermined arithmetic operation is executed from the electric current flowing into the electrodes 4 and from the voltage across the pair of electrodes 4 to find it as Joule heat.

Next, from the integrated value of the quantity of head found by measuring the quantity of heat, the control unit 8 decides if a preset quantity of heat is reached (if a quantity of heat necessary for completing the junction is reached) (step S6).

When it is decided that the integrated value of the quantity of heat has exceeded the preset quantity of heat, it is regarded that the junction is completed (see FIG. 6), and the control unit 8 sends a current interruption instruction to the welding power source 5 (step S7).

According to the above fusing apparatus 1, the fusing process is divided into the process of peeling the coating and the process of thermal caulking, and corresponding controls are executed in these processes to realizing the fusing featuring a stable junction strength.

In other words, the process of thermal caulking monitors if the preset quantity of heat is reached and interrupts the flow of electric current when the preset quantity of heat is exceeded. Therefore, the quantity of heat imparted to the work is optimized to obtain a stable junction strength.

As described above, the fusing apparatus 1 executes the two processes in optimum manners making it possible to stabilize the junction strength even when a terminal that has not been electroplated is fused as well as to suppress the cost of producing the products.

Verified bellow are the effectiveness of the process of peeling the coating and the process of thermal caulking executed by the above fusing apparatus 1 according to the procedure of control of FIG. 7.

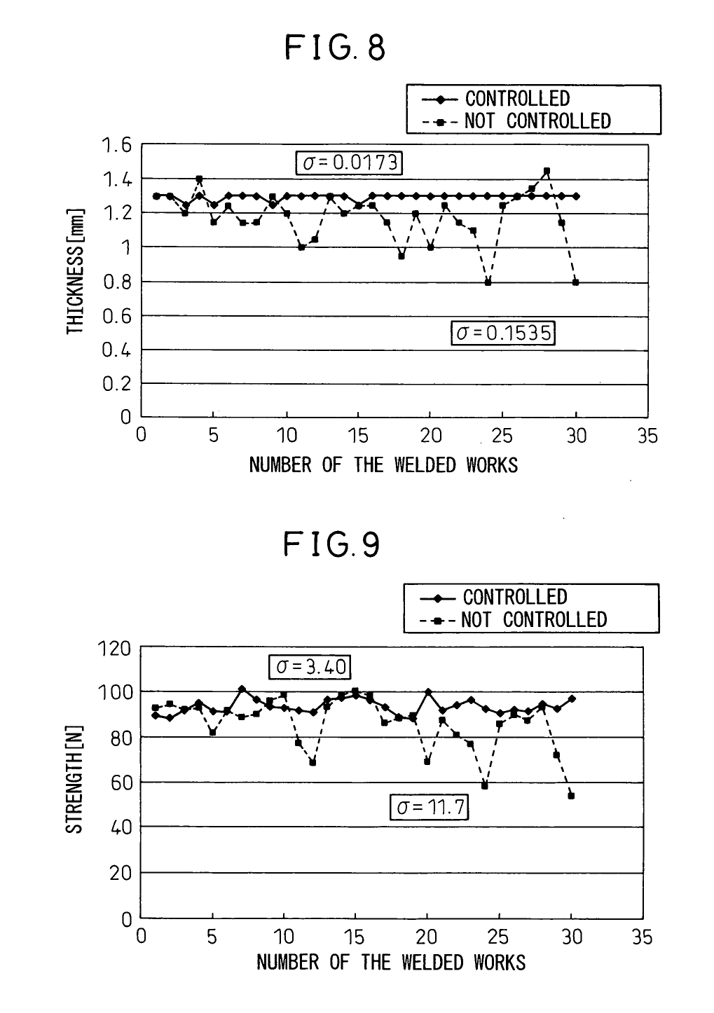

FIG. 8 illustrates the measured values of thicknesses (mm) of the works attained by the welding as executed by the process based on the above procedure of control and by a conventional process.

As will be easily understood from FIG. 8, when the welding is conducted many times according to the process based on the above procedure of control, dispersion (σ=0.0173) in the thickness of the work is very smaller than that (σ=0.1535) according to the conventional process. It will therefore be learned that a stable welding is realized by executing the process based on the above procedure of control.

FIG. 9 illustrates tensile strengths (N) at the welded portions of each of the welded works.

As will be obvious from FIG. 9, when the welding is conducted according to the process based on the above procedure of control, dispersion (σ=3.40) in the welding strength is very smaller than that (σ=11.7) according to the conventional process. It will therefore be learned that the welding executed by the process based on the above procedure of control features a very high stability in the welding strength.

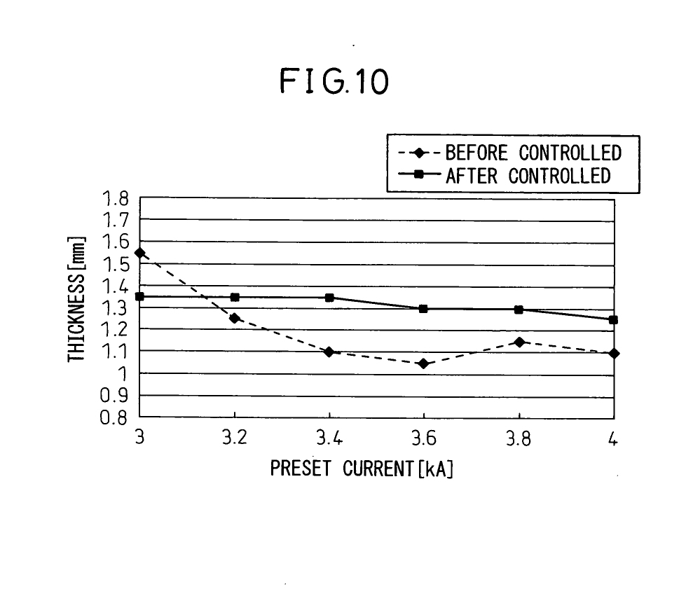

FIG. 10 illustrates variation in the thickness of the work when the electric current is varied.

In this case, as will be obvious from FIG. 10, when the welding is executed by the process based on the above procedure of control, thickness of the work varies little. It will therefore be learned that a stable welding is realized by executing the process based on the above procedure of control.

While the invention has been described by reference to specific embodiments chosen for purpose of illustration, it should be apparent, to those skilled in the art, that numerous modifications could be made thereto without departing from the basic concept and scope of the invention.

1. A method of controlling the fusing by executing:
a process of peeling the coating by correspondingly controlling the electric current flowing into a coated electric wire through a bent terminal while monitoring the surface temperature of the bent terminal at the time of welding a work that has the coated electric wire held by the bent terminal by flowing the electric current into the coated electric wire through the bent terminal; and
a process of thermal caulking by correspondingly controlling the electric current flowing into the coated electric wire through the bent terminal while monitoring the quantity of heat generated in the work.

2. The method of controlling the fusing according to claim 1, wherein the process of peeling the coating correspondingly controls the electric current flowing into the coated electric wire through the bent terminal while monitoring the surface temperature of the bent terminal, detecting the timing at which the temperature rises again after having dropped once, and so regarding that the coating of the coated electric wire has sublimated and peeled.

3. The method of controlling the fusing according to claim 1, wherein the process of thermal caulking measures the quantity of heat generated in the work to find the quantity of heat that is imparted, and interrupts the flow of current at a moment when the quantity of heat has reached a preset quantity of heat.

4. A fusing apparatus for conducting the fusing to weld a coated electric wire in a manner of being held in a bent terminal, comprising:
a pair of electrodes for holding a work having the coated electric wire held in the bent terminal;
a welding power source for flowing an electric current to the electrodes;
a temperature-measuring device for detecting the surface temperature of the bent terminal;
a current sensor for detecting the electric current flowing into the electrodes;
a process of peeling the coating which monitors the surface temperature of the bent terminal using the temperature-measuring device, detects the timing at which the temperature rises again after having dropped once, outputs a control signal to a welding power source, and correspondingly controls the electric current flowing into the coated electric wire through the bent terminal, and a control unit which integrates the surface temperatures of the bent terminal to find a quantity of heat that is imparted, and outputs a control signal for interrupting the flow of electric current at a moment when the quantity of heat has reached a preset quantity of heat.
